(19) United States
(12) Patent Application Publication
(10) Pub. No.: US 2015/0025938 A1
(43) Pub. Date: Jan. 22, 2015

(54) METHOD AND APPARATUS FOR PRICING NEW PRODUCT, SERVICE OR SOLUTION

(71) Applicant: ATIF HUSSAIN, HYDERABAD (IN)

(72) Inventor: ATIF HUSSAIN, HYDERABAD (IN)

(73) Assignee: ATIF HUSSAIN

(21) Appl. No.: 13/945,903

(22) Filed: Jul. 19, 2013

(51) Int. Cl. G06Q 30/02

(52) U.S. Cl. CPC G06Q 30/0206
USPC 705/7.35

(57) ABSTRACT

Embodiments of the present invention relate to method and apparatus for pricing at least one of a new product, service or solution. The method comprises launching the new product, service or solution at an initial price, iteratively varying the initial price corresponding to quantities demanded based on a real time feedback, generating a demand schedule by capturing the quantities demanded and correspondingly varying prices, tracing a demand curve based on the demand schedule in real time, determining a demand function and a corresponding demand equation based on the demand curve and repeating step b to reach a point on the demand curve at which the profit margin is a maximum.

### BACKGROUND OF THE INVENTION

1. Field of the Invention

Embodiments of the present invention generally relate to pricing of products, services and solutions, and more particularly, to a method and apparatus for pricing new products, services and solutions.

2. Description of the Related Art

Determining the price for a new product is generally a problem. One solution to the problem of determining the price of a new product is to charge a low price for the new product. However, charging a low price for the new product is risky. Since, the seller of the new product not only forgoes significant revenues and profits but also fixes a market value position for the new product at a low level. Time and again, as per the findings of companies, once the prices hit the market raising the market prices turns out to be difficult. Since, potential revenues that could have been earned are lost entirely on a continuous basis. For example, 80 to 90 percent of all poorly chosen prices are low.

One solution to the problem of low (or under) pricing a new product is to charge high for the new product, i.e., overpricing. However, charging a high price for the new product is again a problem. Many times, success of the launch of products is based on positive word-of-mouth marketing (WOMM), also called word of mouth advertising, by the early adopters (or lighthouse customers). Thus, another problem is that early adoption of a new product may be crippled by overpricing at the start or launch. One solution to the problem of overpricing is reduction of the price later-on. However, due to delay in reduction of the price the newness to attract early adopters no longer holds. Furthermore, commercial pressures do not allow swift price lowering to salvage lower than expected sales.

Thus, both overpricing and under pricing are costly to businesses. Other than comparables to an existing portfolio of products, which can be misleading, there is rarity of scientific methods to arrive at a price.

A further related problem is companies consistently undercharge for new or existing products despite spending millions or even billions of dollars to develop new products or acquire existing products. On the other hand, just like businesses, private consumers always demand more for less, thus the prices of personal computers, for example, have been pushed downward despite higher processor speeds and additional memory of the personal computers. Global competition, increased pricing transparency, and lower barriers to entry in many of the most attractive industries have contributed to the trend. Still, there are other problems. Many companies want to make a quick grab for market share or return on investment (ROI), and with high prices both objectives can be harder to achieve.

One of the first makers of portable bar code readers, for example, calculated how quickly the customers of the portable bar code readers would be able to assemble native or indigenous products if the customers used portable readers. The company then considered the price of the older, stationary readers and raised it proportionally, solely to account for the time savings. Such a strategy also fit in with the company's desire to penetrate the market quickly. However, by using an existing product as the reference point, the company undervalued a revolutionary product. The portable reader not only improved existing processes but also enabled companies to redesign their supply chains. Portability and instant access to information prepared the way for real-time inventory control, vastly improved logistics planning, and just-in-time (JIT) deliveries, thus eliminating the need for large inventories. Buyers quickly recognized a bargain and flocked to the low-priced product. The company, which failed to keep up with the demand, not only failed to capture the full value of the portable bar code reader but also set the market price expectations at a very low level. A single bad decision easily erased 1 billion USD or more in potential profits for the industry.

Analyses based on cost differences and process improvements are parts of the puzzle, and so is an understanding of the competitive landscape. But, good pricing decisions are based on an expansive rather than an incremental approach. Before zeroing in on a price that promises the greatest long-term profitability, companies must know both the highest and the lowest prices the companies can charge. Price-benefit analysis should begin early in the new product development cycle, when the market is first being probed, for it not only shows companies whether price barriers might make products unfeasible, but can also guide the development of the companies by indicating which attributes customers are most willing to pay for.

Some solutions for products that replicate others on the market, i.e., “me-too” products, or that offer small improvements, i.e. evolutionary products, where the room to maneuver is relatively narrow, suggest incremental approaches for pricing the “me-too” or evolutionary products that may come close to the optimal price. However, a lot of money can be left on the table. For example, charging just 1% percent less than the optimal price for a product can mean forfeiting about 8% percent of the potential operating profit of the product. Thus, the more novel a product may be, the more important is a broader view of the pricing possibilities for companies.

Since incremental approaches tend to focus on the lower end of the price range, companies should start by defining the opposite (or upper) end of the spectrum. However, such a price ceiling, based on a product's benefits, may ultimately prove to be unrealistic. Since, there may not be a sufficient market at that level, it may leave too much room for competitors, or customers may be strong enough to demand a greater share of the value the product creates. But establishing a price ceiling will ensure that each and every potential price point is brought up for discussion.

Hence there is a need for effective methods, apparatuses for pricing new product, service or solution.

### SUMMARY OF THE INVENTION

Embodiments of the invention generally relate to a method for pricing of at least one of a new product, service and solution. The method comprises (a) launching the at least one of the new product, service or solution at an initial price, (b) iteratively varying the initial price corresponding to quantities demanded based on a real time feedback, (c) generating a demand schedule by capturing the quantities demanded and correspondingly varying prices, (d) tracing a demand curve based on the demand schedule in real time, (e) determining a demand function and a corresponding demand equation based on the demand curve and (f) repeating step (b) to reach a point on the demand curve at which the profit margin is a maximum.

These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a block diagrammatic representation of a system 100 facilitating pricing of new products, services and solutions, according to one or more embodiments;

FIG. 2 is an example demand curve represented using a 2D rectangular right-handed coordinate system, according to one or more embodiments;

FIG. 3 depicts a flow diagram of a method 300 for pricing a new product, service or solution, according to one or more embodiments; and

FIG. 4 depicts a computer system that can be utilized in various embodiments of the present invention, according to one or more embodiments.

While the method and apparatus is described herein by way of example for several embodiments and illustrative drawings, those skilled in the art will recognize that method and apparatus for pricing new products, services and solutions is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of method and apparatus for pricing new products, services and solutions defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Proposed embodiments facilitate pricing of at least one of a new product, service and solution. According to some embodiments, a method for pricing of at least one of a new product, service and solution comprises (a) launching the at least one of the new product, service or solution at an initial price, (b) iteratively varying the initial price corresponding to quantities demanded based on a real time feedback, (c) generating a demand schedule by capturing the quantities demanded and correspondingly varying prices, (d) tracing a demand curve based on the demand schedule in real time, (e) determining a demand function and a corresponding demand equation based on the demand curve and (f) repeating step (b) to reach a point on the demand curve at which the profit margin is a maximum.

Various embodiments of method and apparatus for pricing of at least one of a new product, service and solution are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

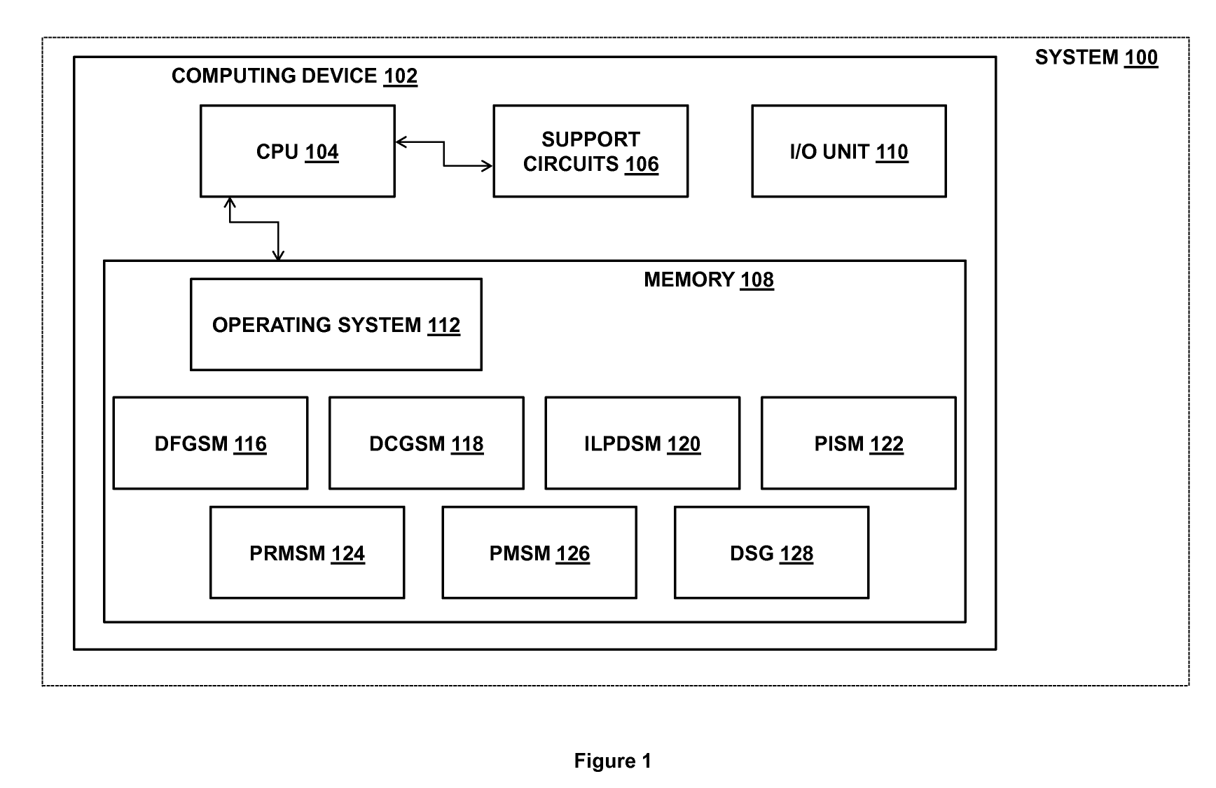

FIG. 1 shows a block diagrammatic representation of a system 100 facilitating pricing of new products, services and solutions. The system 100 comprises a computing device 102. The computing device 102 includes a CPU 104, support circuits (SC) 106, a memory 108 and I/O unit 110. The CPU 104 may comprise one or more commercially available microprocessors or microcontrollers that facilitate data processing and storage. The various support circuits 106 facilitate the operation of the CPU 104 and include one or more clock circuits, power supplies, cache, input/output circuits, and the like. The memory 108 comprises at least one of Read Only Memory (ROM), Random Access Memory (RAM), disk drive storage, optical storage, removable storage and/or the like. The memory 108 comprises an Operating System (OS) 112 and a new product pricing management module (NPPMM) 114.

The NPPMM 114 comprises a demand function generator sub-module (DFGSM) 116, a demand curve generator sub-module (DCGSM) 118, an initial launch price determination sub-module (ILPDSM) 120, a price increment sub-module (PISM) 122, a price risk management sub-module (PRMSM) 124, a profit maximization sub-module (PMSM) 126 and a demand schedule generator (DSG) 128.

The ILPDSM 120 facilitates determination of an initial price of a new product, service or solution in a launch phase of a lifecycle of the new product, service or solution. The ILPDSM 120 facilitates determination of the initial price of the new product, service or solution in a manner such that the market size of the new product, service or solution is a maximum.

The PRMSM 126 is capable of managing the risks involved in under pricing the new product, service or solution in the launch phase.

The PRMSM 126 overcomes the risks of under and overpricing independent of at least one of stored knowledge and intelligence of a new or existing market, a new product, service or solution. The PRMSM 126 derives important pricing knowledge from the new or existing market for the new product, service or solution. In some embodiments, the PRMSM 126 utilizes at least one of variable pricing, real-time pricing or dynamic pricing, real time analytics and risk management and real-time risk management for managing the risks involved in under pricing the new product, service or solution in the launch phase.

In some embodiments, for services of a fee-based nature or renting or leasing of goods or products, the risks of under pricing are capped by flexibility of raising prices if the demand is high and/or market is seen to be ready for higher prices. The risks of under pricing capped by flexibility of raising prices on high demand and/or market readiness for high price is applicable for sales of all services, renting or leasing, and short-lived goods, where underpriced goods cannot be retained by customers and does not hurt the seller or company later.

In some embodiments, for outright sale the launch of the new product is handled by initially leasing out the new product. Initially leasing out the new product for outright sale at the launch of the new product falls under the category of rental services, which are launched at an initial lease price, and through iterations, an optimal market price is determined for the leased service. Based on the optimal lease price thus determined, and the life of the product, optimal price for outright sale is derived.

The PISM 122 facilitates incrementation of the price of the new product, service or solution. The PISM 122 facilitates in iteratively varying the initial price corresponding to quantities demanded based on a real time feedback.

The DSG 128 is capable of generating a demand schedule by capturing the values of quantities demanded and correspondingly varying prices. The demand schedule is a demand data set of ordered pairs corresponding to demand points. Each ordered pair (Q, P) corresponding to a demand point in the data set comprises an abscissa represented by an independent variable, namely a quantity demanded (Q), and an ordinate represented by a dependent variable, namely a price (P). The demand schedule is a tabular representation of the relationship between the quantities demanded (Qs) and correspondingly varying prices price (Ps) respectively. For example, Table 1 below is a tabular representation of a given exemplary demand schedule.

| PRICE (P) | QUANTITY DEMANDED (Q) |
|---|---|
| 5 | 10 |
| 4 | 17 |
| 3 | 26 |
| 2 | 38 |
| 1 | 53 |

The DCGSM 118 is capable of generating or tracing a demand curve based on the demand schedule, in real time. The demand curve is two-dimensional (2D) and is graphical representation of the relationship between the quantities demanded (Qs) and correspondingly varying prices price (Ps) respectively. All other factors affecting the demand are considered constant. However, all the other factors that are considered constant are part of the demand curve and influence the location of the demand curve. In some embodiments, if the demand curve is moving, due to growth in a new market, profit maximization point can still be reasonably estimated both in accordance with the principles of the invention and other standard methods.

In general, the demand curve is a two-dimensional depiction of the relationship between price and quantity demanded. Movements along the curve occur only if there is a change in quantity demanded caused by a change in the good's own price. A shift in the demand curve, referred to as a change in demand, occurs only if a non-price determinant of demand changes. For example, if the price of a complement were to increase, the demand curve would shift leftward reflecting a decrease in demand. Conversely, a rightward shift in the demand curve reflects an increase in demand. The shifted demand curve represents a new demand equation.

Movement along a demand curve due to a change in the good's price results in a change in the quantity demanded, not a change in demand. A change in demand refers to a shift in the position of the demand curve in two-dimensional space resulting from a change in one of the other arguments of the demand function.

The DFGSM 116 is capable of generating a demand function and a corresponding demand equation based on the demand curve. Specifically, the DFGSM 116 is capable of generating a demand function using the demand schedule. The demand function is represented by a demand equation, namely Equation 1:

P=F (Q), where P is the price and Q is the quantity demanded. Equation 1

In some embodiments, the DFGSM 116 is capable of generating a demand function and a corresponding demand equation based on the demand curve using backtracking.

The PMSM 126 facilitates determination a demand point on the demand curve at which the profit margin is a maximum. In some embodiments, the PMSM 126 determines the demand point at which the profit margin is the maximum by implementing the PISM 122. The PISM 122 facilitates in iteratively varying the price of the new product, service or solution corresponding to quantities demanded based on a real time feedback to reach the demand point at which the profit margin is the maximum. The PMSM 126 facilitates determination of a total cost of production of the new product, service or solution. The PMSM 126 facilitates calculation of a profit margin corresponding to each price point on the demand curve. The PMSM 126 facilitates multiplication of the profit margin by a quantity demanded for each price point. The PMSM 126 facilitates determination of a price point at which a corresponding a quantity demanded produces the maximum profit margin by comparing with each price point.

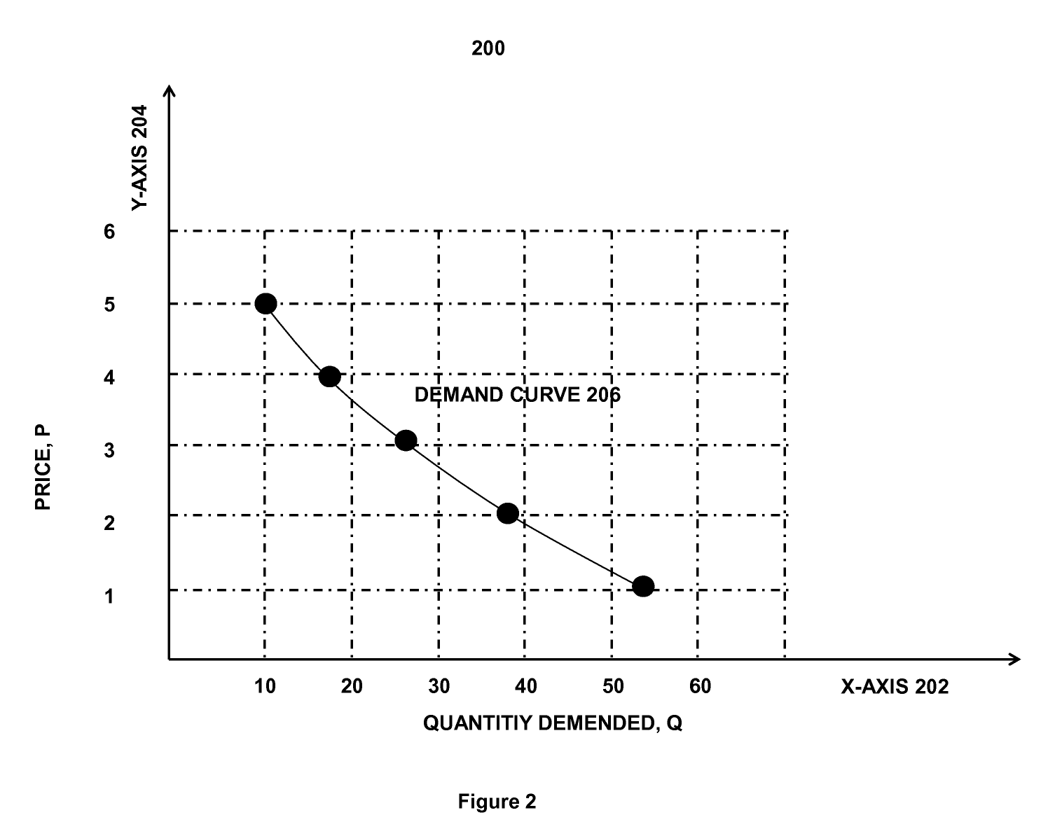

FIG. 2 is an example demand curve represented using a 2D rectangular right-handed coordinate system.

A 2D rectangular coordinate system 200 comprises a horizontal X-axis 202 and a vertical Y-axis 204. The horizontal X-axis 202 represents a quantity demanded, which is an independent variable, for a new product, service or solution. The vertical Y-axis 204 represents a price corresponding to the quantity demanded, which is a dependent variable, for the new product, service or solution. The horizontal X-axis 202 and vertical Y-axis 204 intersect each other at the origin of the 2D rectangular coordinate system 200.

As shown in FIG. 2, the increments in the price move vertically upwards along the positive direction of the Y-axis 204 from the origin, such that the highest price is nearest to the top of the Y-axis 204. The increments in the quantity demanded move horizontally right along the positive direction of the X-axis 202 from the origin, such that the lowest quantity demanded is nearest to the origin. Each increment interval along each of the X- 202 and Y-axes 204 is equally spaced. The demand points (i.e., the correlative quantity for each price at which there is a buyer) are plotted within the plane defined by the X- 202 and Y-axes 204 to correspond to both a price on the Y-axis 204 and a quantity demanded on the X-axis 202. By connecting the demand points, the demand curve 206 is formed. The demand points along the demand curve 206 show how the quantity demanded depends on the price of the goods. Since price will always have a negative effect on consumer demand, all demand curves will have a downward slope.

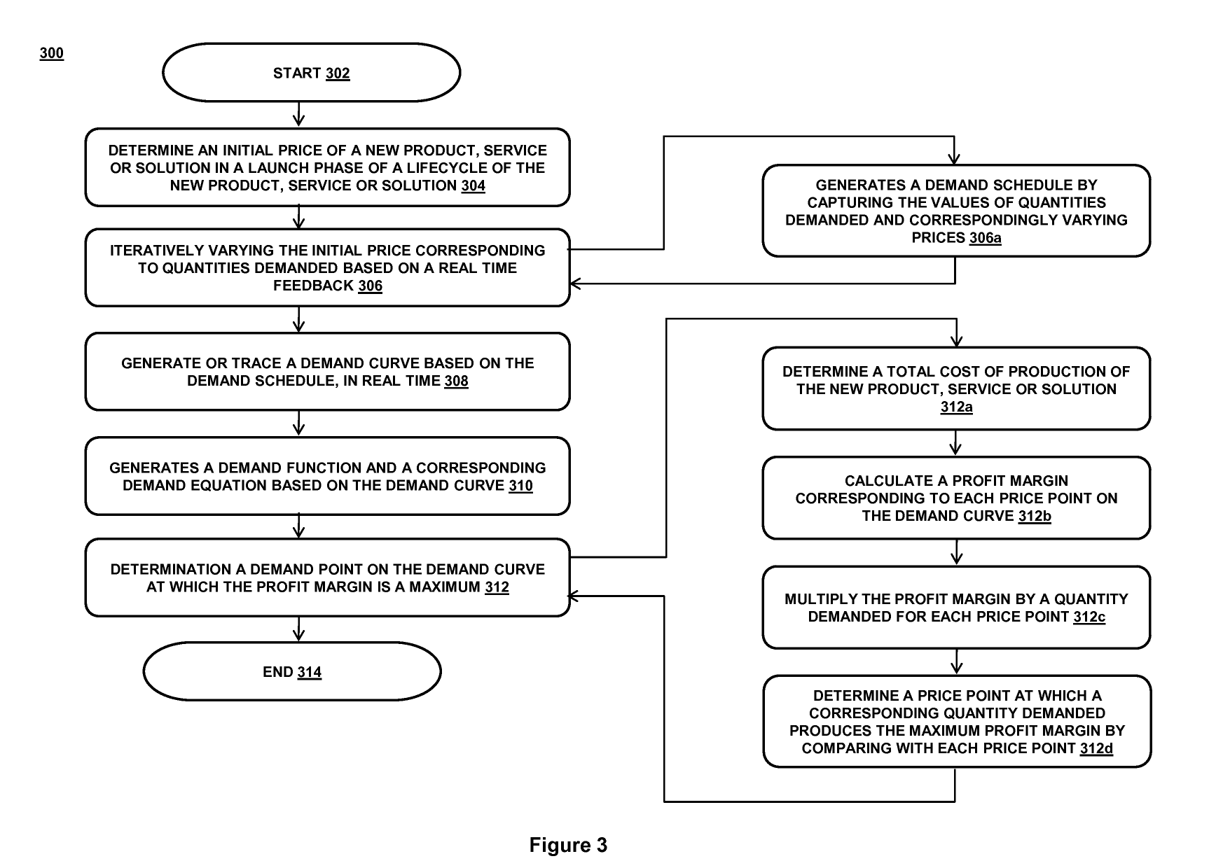

FIG. 3 depicts a flow diagram of a method 300 for pricing a new product, service or solution, according to one or more embodiments. The method 300 starts at step 302 and proceeds to step 304.

The NPPMM 114 comprises a demand function generator sub-module (DFGSM) 116, a demand curve generator sub-module (DCGSM) 118, an initial launch price determination sub-module (ILPDSM) 120, a price increment sub-module (PISM) 122, a price risk management sub-module (PRMSM) 124, a profit maximization sub-module (PMSM) 126 and a demand schedule generator 128.

At step 304, the method 300 implements the ILPDSM 120 of FIG. 1. The ILPDSM 120 facilitates determination of an initial price of a new product, service or solution in a launch phase of a lifecycle of the new product, service or solution. The ILPDSM 120 facilitates determination of the initial price of the new product, service or solution in a manner such that the market size of the new product, service or solution is a maximum.

In some embodiments, the method 300 implements the PRMSM 124 of FIG. 1. The PRMSM 124 facilitates determination of an initial launch price of a new product, service or solution such that the market size of the new product, service or solution is a maximum.

At step 306, the method 300 implements the PISM 122 of FIG. 1. The PISM 122 facilitates incrementation of the price of the new product, service or solution. The PISM 122 facilitates in iteratively varying the initial price corresponding to quantities demanded based on a real time feedback.

At step 306a, the method 300 implements the DSG 128 of FIG. 1. The DSG 128 generates a demand schedule by capturing the values of quantities demanded and correspondingly varying prices. In some embodiments, the demand schedule is compiled by capturing or recording quantities demanded and corresponding prices for the new product, service or solution, in real time.

At step 308, the method 300 implements the DCGSM 118 of FIG. 1. The DCGSM 118 generates or traces a demand curve based on the demand schedule, in real time.

At step 310, the method 300 implements the DFGSM 116 of FIG. 1. The DFGSM 116 generates a demand function and a corresponding demand equation based on the demand curve. In some embodiments, the DFGSM 116 generates a demand function using the demand curve using backtracking.

At step 312, the method 300 implements the PMSM 126 of FIG. 1. The PMSM 126 facilitates determination a demand point on the demand curve at which the profit margin is a maximum. In some embodiments, the PMSM 126 determines the demand point at which the profit margin is the maximum by implementing the PISM 122 of FIG. 1. The PISM 122 facilitates in iteratively varying the price of the new product, service or solution corresponding to quantities demanded based on a real time feedback to reach the demand point at which the profit margin is the maximum.

At step 312a, the PMSM 126 facilitates determination of a total cost of production of the new product, service or solution.

At step 312b, the PMSM 126 facilitates calculation of a profit margin corresponding to each price point on the demand curve.

At step 312c, the PMSM 126 facilitates multiplication of the profit margin by a quantity demanded for each price point.

At step 312d, the PMSM 126 facilitates determination of a price point at which a corresponding quantity demanded produces the maximum profit margin by comparing with each price point.

The method 300 proceeds to step 314 and ends.

The embodiments of the present invention may be embodied as methods, system, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java.®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

### Example Computer System

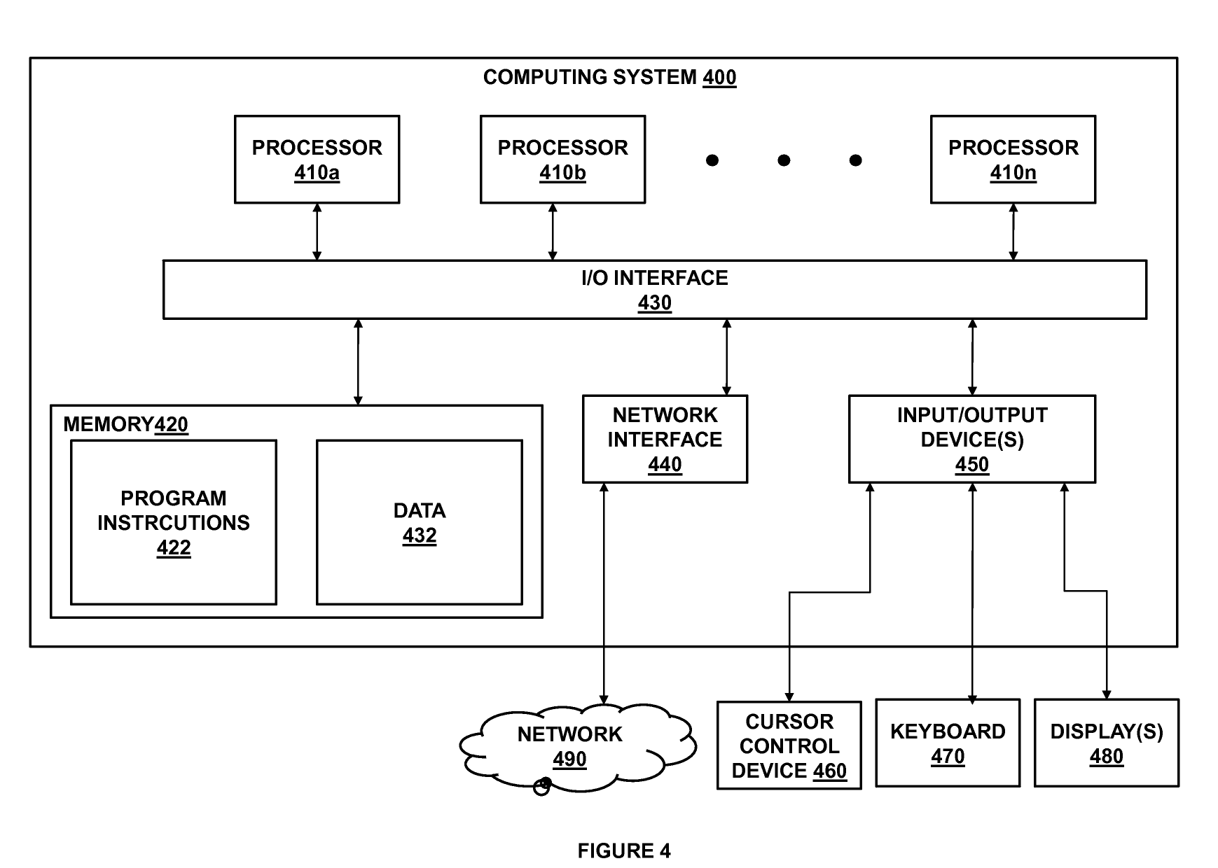

FIG. 4 depicts a computer system that is a computing device and can be utilized in various embodiments of the present invention, according to one or more embodiments.

Various embodiments of a method and apparatus for pricing new products, services and solutions, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement method 300 as processor-executable executable program instructions 422 (e.g., program instructions executable by processor(s) 410a-n) in various embodiments.

In the illustrated embodiment, computer system 400 includes one or more processors 410a-n coupled to a system memory 420 via an input/output (I/O) interface 430. The computer system 400 further includes a network interface 440 coupled to I/O interface 430, and one or more input/output devices 450, such as cursor control device 460, keyboard 470, and display(s) 480. In various embodiments, any of components may be utilized by the system to receive user input described above. In various embodiments, a user interface (e.g., user interface) may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410a-n may be any suitable processor capable of executing instructions. For example, in various embodiments processors 410 may be general-purpose or embedded processors implementing any of a variety of instruction set architectures (ISAs), such as the x96, PowerPC, SPARC, or MIPS ISAs, or any other suitable ISA. In multiprocessor systems, each of processors 410a-n may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one components (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the methods described above, such as the method illustrated by the flowchart of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for pricing at least one of a new product, service and solution comprising:
(a) launching at least one of the new product, service and solution at an initial price;
(b) iteratively varying the initial price corresponding to quantities demanded based on a real time feedback;
(c) generating a demand schedule by capturing the quantities demanded and correspondingly varying prices;
(d) tracing a demand curve based on the demand schedule in real time;
(e) determining a demand function and a corresponding demand equation based on the demand curve; and
(f) repeating step b to reach a point on the demand curve at which the profit margin is a maximum.

2. The method of claim 1, wherein launching the at least one of the new product, service and solution further comprising:
setting at least one of an initial maximum and a minimum price in a launch phase of a lifecycle of the at least one of the new product, service and solution such that the market size of the new product, service or solution is a maximum; and
managing risks associated with at least one of under and overpricing at least one of the new product, service and solution during the launch phase of a lifecycle of the new product.

3. The method of claim 2, wherein managing risks associated with the under and overpricing at least one of the new product, service and solution comprises using at least one of real-time pricing, real time analytics and risk management, and real-time risk management in the launch phase.

4. The method of claim 2, wherein managing risks associated with the under and overpricing at least one of the new product, service and solution further comprising:
determining whether at least one of the new product, service and solution is at least one of a fee-based or paid and rental or leasing service;
determining qualitative and quantitative parameters in connection with the market and demand for the service market positioning, acceptance, readiness and demand
varying the price based on the determined qualitative and quantitative parameters.

5. The method of claim 4, wherein the qualitative and quantitative parameters in connection with the market and demand for the service is at least one of market positioning, acceptance, readiness and demand of the service.

6. The method of claim 2, wherein managing risks associated with the under and overpricing the new product, service or solution further comprising:
determining whether at least one of the new product, service and solution is a product;
launching the product on lease at an initial lease price;
iteratively varying the initial price corresponding to quantities demanded based on a real time feedback to obtain an optimal lease price;
determining an optimal price of the product based on the optimal lease price and the life of the product.

7. The method of claim 1, wherein repeatedly increasing the price of the new product to find the demand point at which the profit margin is a maximum further comprising:
determining a total cost to produce the new product;
calculating a profit margin for each price point on the demand curve;
multiplying the profit margin by a quantity demanded for each price point; and
finding the price point at which the demand produces the greatest profit margin by comparing each price point.

8. The method of claim 1, wherein iteratively varying the initial price corresponding to quantities demanded based on a real time feedback further comprising:
setting at least a minimum of three distinct prices for the new product through at least a pair of price increments based on the aftermath of launch.
